(19) United States
(12) Patent Application Publication
(10) Pub. No.: US 2015/0206396 A1
(43) Pub. Date: Jul. 23, 2015

(54) CASINO WAGERING SYSTEM WITH SHARED PROGRESSIVE JACKPOT

(71) Applicant: Chi Fat Au-Yeung, Birmingham (GB)

(72) Inventor: Chi Fat Au-Yeung, Birmingham (GB)

(21) Appl. No.: 14/158,817

(22) Filed: Jan. 18, 2014

(51) Int. Cl. G07F 17/32

(52) U.S. Cl. CPC G07F 17/3258; G07F 17/3293

(57) ABSTRACT

A method, system, and computer readable storage to implement a progressive jackpot system for a table game with a lucky seat feature. A random lucky seat is selected from all of the seats at the table, whether they are being played or not. If a particular outcome occurs on the game, then if the player at the lucky seat played the progressive wager, then that player receives a progressive jackpot payout. Other players at the table who played the progressive wager will also receive a progressive jackpot payout but less than the progressive jackpot payout that the player at the lucky seat received. The game can be applied to games such as baccarat, roulette, bingo and other games.

### BACKGROUND OF THE INVENTION

1. Field of the Invention

The present general inventive concept is directed to a method, apparatus, and computer readable storage medium directed to a wagering game.

2. Description of the Related Art

Progressive jackpots allow a player to make a separate progressive wager which funds a dynamic jackpot, and when a player achieves a particular outcome the player can win the entire jackpot (see U.S. Pat. Nos. 4,861,041 and 5,078,405 both to Jones).

### SUMMARY OF THE INVENTION

It is an aspect of the present invention to provide an exciting progressive jackpot system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method to implement a progressive jackpot, according to an embodiment;

FIG. 2 is a drawing of a gaming table and layout according to an embodiment;

FIG. 3 is a block diagram of electronics used to implement a progressive jackpot system, according to an embodiment;

FIG. 4 is a flowchart illustrating an exemplary method of implementing a progressive jackpot dealing procedure, according to an embodiment;

FIG. 5A is a drawing illustrating a gaming table, according to an embodiment;

FIG. 5B is a block diagram illustrating an electronic player tracking system associated with each gaming table, according to an embodiment;

FIG. 6A is a block diagram illustrating exemplary hardware that can be used to implement an electronic version of the methods described herein; and

FIG. 6B is a block diagram illustrating an exemplary network configuration to implement a player playing an online version of the methods described herein;

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

Progressive jackpots are described in U.S. Pat. Nos. 4,861,041 and 5,078,405, both patents of which are incorporated by reference herein in their entireties. Embodiments herein relate to a progressive jackpot system which implements a “lucky seat” feature. Upon each new game played, a lucky seat can be randomly determined (typically using an electronic random number generator). The lucky seat is one randomly chosen seat (set of betting circles on a table layout) out of all of the seats at the table (typically eight although can be any other number). Thus, for example if there are eight seats at a table then the lucky seat is one seat randomly chosen out of all eight. The lucky seat is chosen randomly out of all of the seats at the table without regard to whether a player is actually playing at the lucky seat or not (in other words, a player is not required to be playing at a particular seat for it to be chosen as the lucky seat). The lucky seat is also chosen without regard to whether players are playing the progressive jackpot or not (e.g., the randomly determined lucky seat will not be affected by whether a player at that seat is or is not playing the progressive jackpot). The lucky seat is determined after all players have made their progressive wagers (and of course no further progressive wagers are permitted) and then the lucky seat can be displayed in numerous ways (e.g., a betting area on the table lights up to indicate who has the lucky seat, a numerical display outputs a number corresponding to the seat number representing the lucky seat, etc.)

Typically, the progressive jackpot is triggered when a predetermined card combination occurs on a common hand game (such as baccarat). In a common hand game, all players share all of the same cards and thus they all win or lose the progressive jackpot together (which is triggered only by the common cards). One example of a common hand game is baccarat, in which individual players do not get their own cards but instead the same cards are used for all players (e.g., the dealer's hand and the player's hand). The game of baccarat is described in U.S. Pat. No. 6,299,171 and U.S. publication 2008/0032760, both of which are incorporated by reference herein in their entireties.

If a player is sitting at the lucky seat (and the player played the optional progressive wager) then that player wins a larger payout than if the player was not sitting at the lucky seat. Note that if a player chooses not to make the optional progressive wager then the player would not win any payout for the progressive jackpot regardless of what combination of cards occurred. Players who are not sitting at the lucky seat who made the progressive wager will still receive a progressive payout, just not as high as they would have received if they were the lucky seat.

The game can be applied to any game, such as blackjack, baccarat, Pai Gow, roulette, poker, and others. The known game of baccarat is played as follows. The player chooses a bet (a main bet or main wage) to place (player, banker, or tie). The cards are dealt face down, two cards to the player and two cards to the banker, all face up. Depending on the two initial hands, both the player and the banker may draw a third card or stand. The hand with the higher total wins.

If the player or the banker (or both) achieve a total of 8 or 9 on the initial deal (known as a ‘natural’), no further cards are drawn and the game is evaluated based on both initial two card hands. If neither player has a natural, then the play proceeds as follows. If the player has an initial total of 0-5, the player draws a third card. If the player then has an initial total of 6 or 7, the player stands.

If the player stands, the banker uses only the banker's own hand and acts according to the same rule as the player (the banker draws a third card if the banker has 0-5 and stands if the banker has 6 or 7).

If the player drew a third card, then the banker acts according to Table I

TABLE I
Player Draw Card Banker Action

| | |
|---|---|
| 2-3 | banker draws if banker has 0-4, stands if banker has 5-7 |
| 4-5 | banker draws if banker has 0-5, stands if banker has 6-7 |
| 6-7 | banker draws if banker has 0-6, stands if banker has 3-7 |
| 8 | banker draws if banker has 0-2 and stands if banker has 3-7 |
| A, 9, 10 or | banker draws if banker has 0-3 and stands if banker has 4-7 |
| face card | |

The player (player or banker) with the highest hand wins. The score of each hand is computed by taking the physical point total of each hand modulo 10, which means that after adding the value of the cards the tens digit is ignored. For example, a hand of 3 and 4 is 7. A hand of 8 and 6 is scored as 4 (14 modulo 10). The first digit is dropped because the total is higher than 9. A hand consisting of 4 and 6 is worth zero. The highest (best) score that can be achieved is 9 (formed using 4/5; face card/9; A/8, 7/2, etc.)

If the banker has the higher hand then the banker bet wins and if the player has the higher hand then the banker bet loses. If the player has the higher hand then the player bet wins and if the banker has the higher hand then the player bet loses. On event of a tie, the player and banker bets will push (neither win nor lose). The player can also bet on a tie. If the player's point total equals the banker's point total then the tie bet wins, otherwise the tie bet loses.

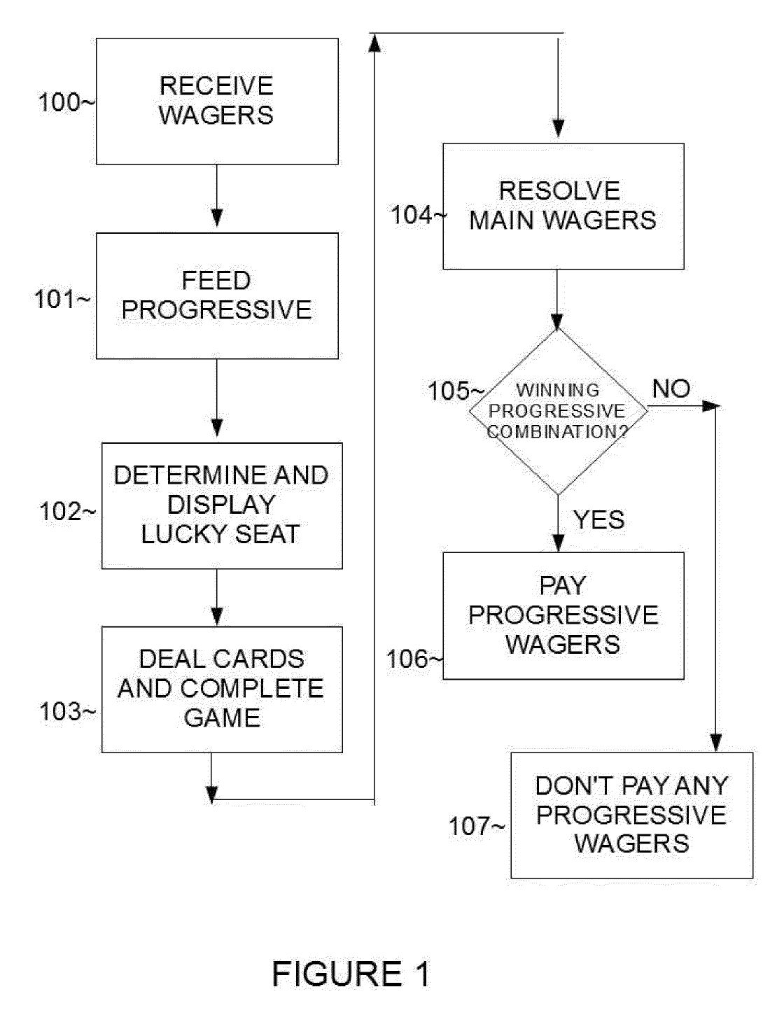

FIG. 1 is a flowchart illustrating an exemplary method to implement a progressive jackpot, according to an embodiment.

The method can begin with operation 100, which receives wagers from players. Main wagers are received for the main game (not related to the progressive) and then an optional progressive wager can be made by each player. The progressive wager can be, for example, $1 (or other fixed amount). Electronics are used such that an indication is made which player made the progressive. For example, a light can be embedded in a progressive betting circle so that when the player makes the progressive wager by placing a $1 chip in his respective progressive betting circle then the light lights up (indicating that this player made the progressive wager). Once all of the lights have lit up indicating which players made the progressive wager than the dealer can collect all of the progressive bets (chips). Other mechanisms can be used to track which players made the progressive wagers as well, such as a computer can display on an output device to the dealer which players made the progressive wager (identified by the seat number at the table). Note that before wagers are accepted, the status of which players made the progressive wager would be reset (e.g., by the dealer pressing a button) so that the system reflects that no players made the progressive wager so that from this point on, players who make or don't make the progressive wager can be properly noted by the electronic system. It is important to track which players did and did not make the progressive wager because players who did not make the progressive wager would not be entitled to win any of the progressive jackpot if a triggering condition occurs (card combinations occur that award part or all of the jackpot to players).

From operation 100, the method proceeds to operation 101, which feeds the progressive meter. A predetermined percentage (contribution rate) of the progressive wagers that are collected are added to a progressive jackpot. For example, the contribution rate can be 65%, thus 65% of all progressive wagers are added to the progressive jackpot and the remaining 35% is collected and kept by the house as profit.

Thus, for example, consider a table of eight 8 seats (each seat has its own set of betting circles including a progressive wager betting circle) and that there are five players playing at this table (and thus three empty seats). Of the five players at this table, only three make the progressive wager of $1. Thus, the dealer collects $3 in progressive wager chips, and 65% of $3 ($1.95) is added to the progressive jackpot (as a contribution amount) and thus $1.05 is kept by the house as profit. In reality, all $3 is kept by the house but the $1.95 is constructively “transferred” to the jackpot meter (which displays the current jackpot amount) which is allocate for the player(s) who will next win this progressive jackpot. Thus, this amount really “belongs” to the players, not the house (casino). The electronic system will automatically allocate track the number of progressive wagers made (e.g., number of players who made the progressive wager) and contribute a contribution amount based on the contribution rate to the jackpot meter. The display showing the progressive jackpot amount will automatically increase the contribution amount.

From operation 101, after the progressive wager is closed (no more progressive wagers are allowed), then the method proceeds to operation 102 which determines and displays the lucky seat. The lucky seat is determined randomly (using an electronic random number generator) out of all of the seats at the table (with each seat having an equal chance of being selected). A light can be positioned alongside each seat or set of betting circles indicating which seat was chosen as the lucky seat (this light is different than the light that indicates which players made the progressive wager). Alternatively, a display can display at the table a number (from one to 8) which seat was selected as the lucky seat.

From operation 102, the method proceeds to operation 103, which deals the cards on the table and completes the game based on the game's predetermined rules. Note that any game can be used as the game, such as baccarat, blackjack (the game of blackjack is well known, see U.S. publication 2003/0155715 which is incorporated by reference herein in its entirety), Pai-Gow, etc. The cards used to determine whether the progressive jackpot wins or not should be community cards (common to all players). This can be, for example, all of the cards in baccarat, the dealer's cards in blackjack, etc. In operation 100 the player places main wagers which are based on the outcome of the game but do not involve the progressive wager. Thus, main wagers in baccarat are the banker, player, and tie. In blackjack, the main wager would be the blackjack wager and any side bets offered (but not the progressive wager).

From operation 103, the method proceeds to operation 104 which resolves the main wagers. The main wagers are all wagers on the game except for the progressive wager. This is done according to the rules of the game being played.

From operation 104, the method proceeds to operation 105, which determines whether the game dealer in operation 103 comprises a winning progressive combination. A winning progressive combination is a predetermined combination of cards (e.g., poker rank such as royal flush, etc.) If there is no winning progressive combination, then the method proceeds to operation 107, which does not pay any of the progressive wagers (they all lose). Typically, the overwhelming majority of the time the progressive wagers would lost since getting a winning progressive combination would be an unlikely occurrence. The game is now over and a new game can begin.

In an embodiment, in operation 104 a baccarat game is implemented and the winning progressive combination is determined from the first four cards dealt (the two player cards and the two banker cards which are all dealt face up). A table such as Table II can be used to determine whether a winning progressive combination has occurred.

TABLE II

| Outcome | Payout (for-1) | Distribution |
|---|---|---|
| Identical natural 9 tie | 100% of meter | 44% share to lucky seat, 8% |
| | | to other bettors |
| Identical natural 8 tie | 40% of meter | 44% share to lucky seat, 8% |
| | | to other bettors |
| Natural tie all same suit | 20% of meter | 44% share to lucky seat, 8% |
| | | to other bettors |
| Natural tie all same color | 80 | all bettors |
| Other natural ties | 20 | all bettors |
| No natural tie | 0 (lose) | all bettors |

Note that in Table II an identical natural 9 tie means that the player and banker hands total 9 and also have the same ranks and suits (for example, the player has 4-diamonds 5-hearts and the banker has 5-diamonds 4-hearts), note that the order of cards does not matter. Note that a natural means getting dealt an 8 or 9 (which doesn't require a draw) and thus a natural tie is when the player's total and the banker's total tie with either 8 or 9. Draws are determined by the predetermined baccarat rules (see Table I) and there is no player or dealer discretion involved. An identical natural 8 tie is similar to the identical natural 9 tie but both the player and banker hand must each be a natural 8 with identical cards (for example, the player has 5-diamonds-3-spades and the banker has 5-diamonds, 3-spades). A natural tie all same suit is a natural tie (the initial player and initial banker hand tie with 8 or 9 with all four cards being the same suit), for example the player has 4-clubs and 5-clubs and the banker has 6-clubs and 3-clubs (both are naturals totaling 9). A natural tie same all same color is a natural tie with all cards being the same color but not all the same suit, for example the player having 3-hearts and 5-diamonds and the banker having 2-diamonds and 6-diamonds (each hand is a natural and all four cards are the same color). Other natural ties is any natural tie (initial two banker's cards and initial two player's cards total both total 8 or both total 9) but does not fall into any of the other outcomes (for example, the player has 3-spades and 5-hearts and the banker has 6-spades and 2-spades). Note that the highest paying outcome will be used for outcomes that can fall into more than one category (e.g., use highest payout possible).

Note that in Table II, the payout column represents if all players at a table of eight are playing the progressive. If less than all eight are playing the progressive, then the jackpot will not be reduced by the full percentage in the payout column. For example, in “identical natural 8 tie”, 40% of the jackpot meter is determined, and then of that 40% 44% is given to the player at the lucky seat playing the progressive and 8% is given to each other player playing the progressive. Of course all players who do not play the progressive do not win a progressive award (even the player at the lucky seat). Thus, for example, of the jackpot meter is at $20,000, and there are 8 players playing the progressive, then upon an identical natural 8 tie, 40% of the jackpot ($8,000) is identified and then the player at the lucky seat gets 44% of the $8,000 ($3,520) and the remaining seven players get 8% of $8,000 or $640. Thus, a total of $8,000 is distributed and the jackpot meter is reduced by this amount and ends up with an amount (display) of $12,000.

When an identical natural 9 tie occurs, a re-seed amount equal to ($8,000) (total % paid) is added to the jackpot. For example, if (44%+8%+8%) (meaning that the player at the lucky seat played the progressive and two other players played the progressive) of the jackpot is paid out, then ($8,000)*(44%+8%+8%) is added back to the progressive total.

If in operation 105, it is determined that a winning progressive combination has occurred in the game (in operation 103), then the method proceeds to operation 106 which pays the progressive wagers out to all players who made the progressive wager according to a predetermined payout table such as that illustrated in Table II. Players who did not make the progressive wager of course do not win any such payout.

For example, if there are 4 players (bettors) who are playing the progressive (i.e. made the progressive wager for the game) sitting at seats number 1, 4, 5, 6 (seats numbered clockwise with seat number 1 the first player to the dealer's left). The lucky seat is displayed as set number 5. The four cards dealt are an identical natural 9 tie. Then the player at search number 5 (who is sitting at the lucky seat) wins 44% of the jackpot (what is displayed on the jackpot meter) and the players at seats 1, 4 and 6 each win 8% of the jackpot. Thus, for example if the progressive jackpot (meter) was $10,000, then the player at seat 4 wins $4,400 and the other three players each win $800, and the progressive meter (also referred to as progressive jackpot meter) goes down to $3,200. It does not matter how many other players are at the table who did not play the progressive jackpot (as these players do not win anything).

As a further example, consider there are 5 players who are playing the progressive sitting at seat numbers 1, 3, 4 and 6, and the lucky seat is displayed as seat number 5. All four players win 8% of the jackpot ($800 each) since there is no player sitting at the lucky seat.

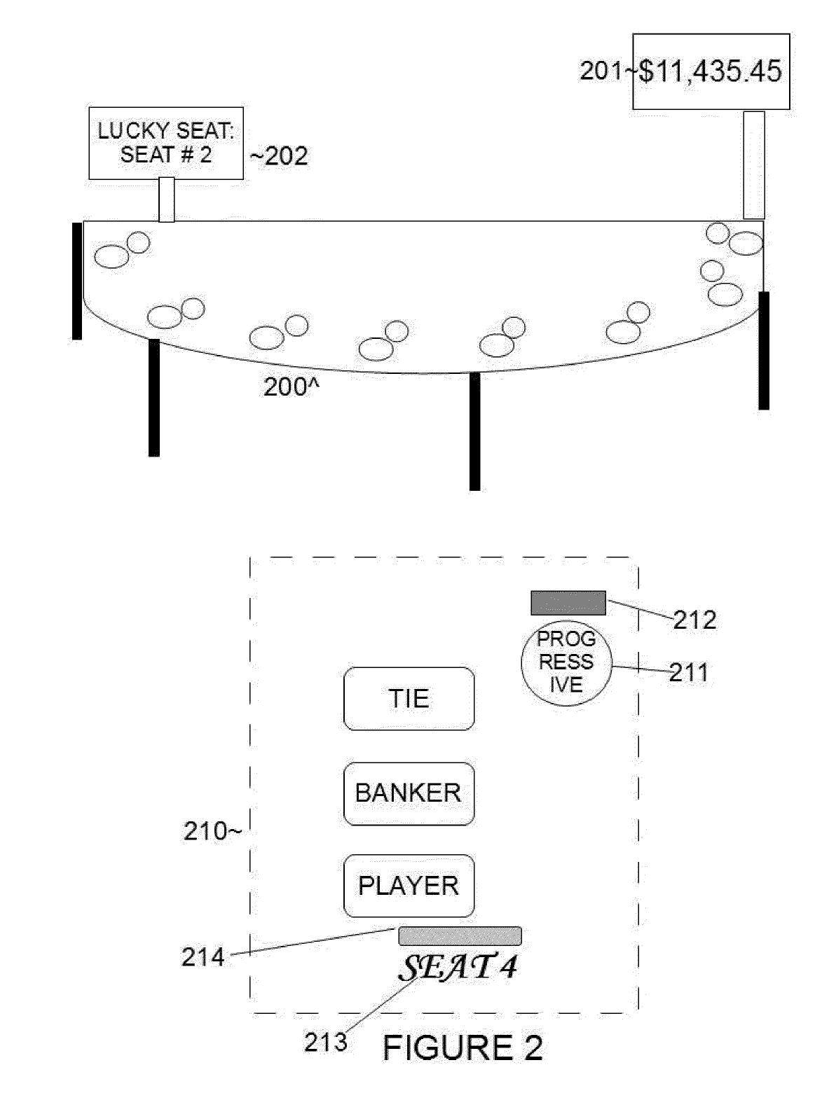

FIG. 2 is a drawing of a gaming table and layout according to an embodiment.

A physical gaming table 200 has eight seats (although of course it can accommodate any other number). This table has one betting circle for a main wager (e.g., on a blackjack game) and a progressive wager betting circle. A progressive jackpot meter 201 shows the current amount of the progressive jackpot. A lucky seat display 202 shows the currently chosen lucky seat which was chosen by a computer.

An individual betting layout 210 is shown for each player for a baccarat game. Each such layout 210 is in front of each of the eight players. A banker, player, and tie betting circles are used to place the main wagers (all wagers can be placed in the form of chips). A progressive wager betting circle 211 is used to place the progressive wager (e.g., a $1 chip). A progressive wager light 212 is used to indicate that this player made the progressive wager. When the player makes the progressive wager, the progressive wage light 212 will light up (and the computer knows which seats/players made the progressive wagers). A seat number 213 is printed on the felt so each player knows their seat number so they can identify which player/seat is chosen as the lucky seat on the lucky seat display 202. A lucky seat light 214 lights up when this seat is selected as the lucky seat.

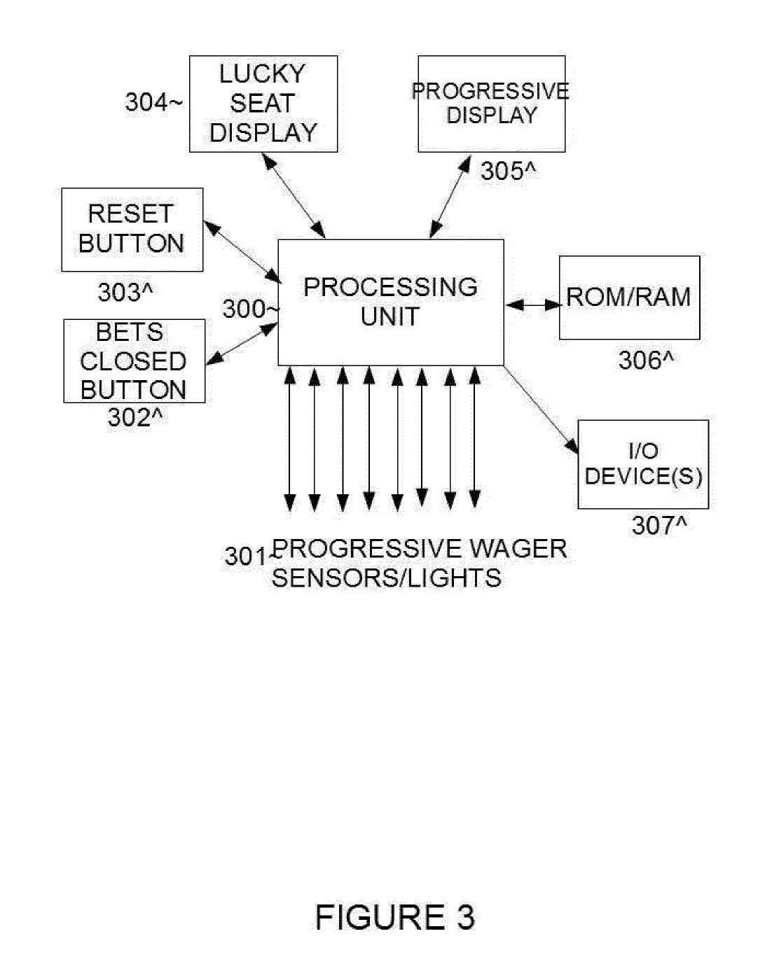

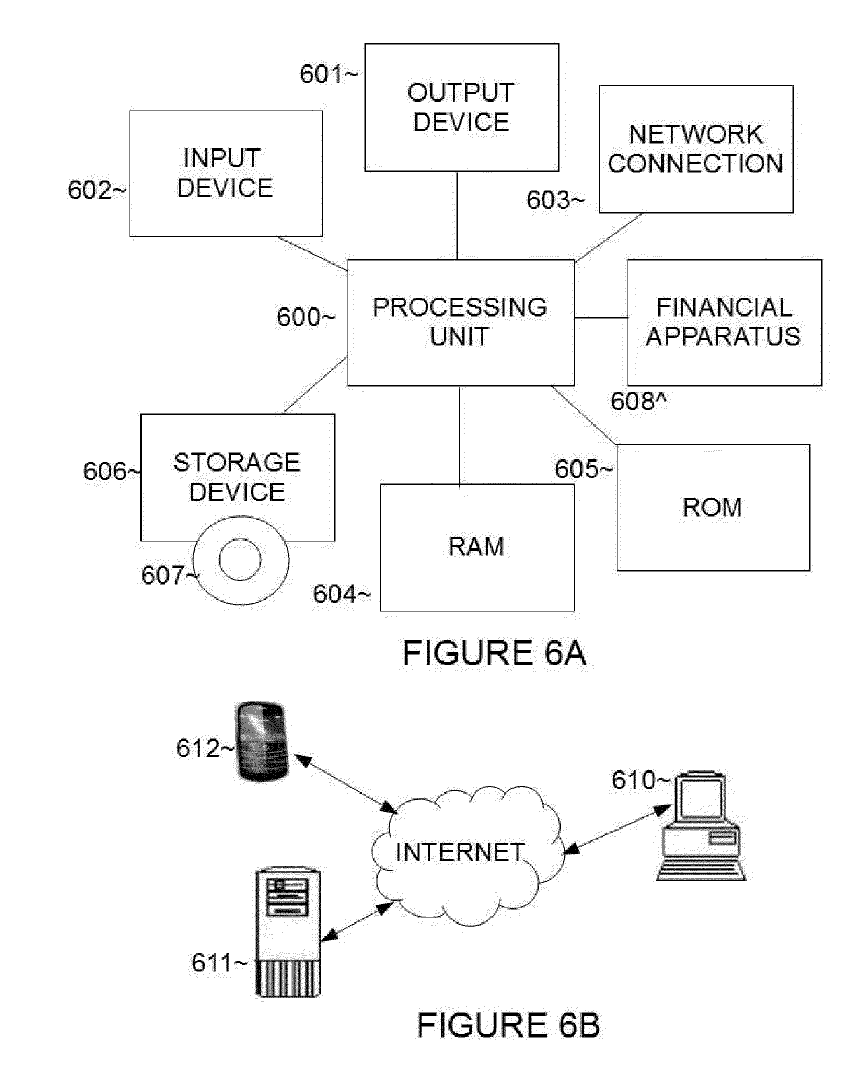

FIG. 3 is a block diagram of electronics used to implement a progressive jackpot system, according to an embodiment. While FIG. 3 illustrates one example of the progressive jackpot system, such as progressive jackpot system can also be implemented by system described illustrated in FIG. 6A.

A processing unit 300 is a microprocessor and related structure (e.g., cache, bus, etc.) The processing unit 300 is programmed to execute computer readable instructions that perform all of the methods described herein. The processing unit 300 is connected to each of the eight progressive wager sensors 301 and progressive wager lights. The progressive wager sensors are sensors nearby (or under) each progressive wager betting circle which detect whether or not a progressive wager has been placed. The progressive wager lights (such as progressive wager light 212) is used to light up when the progressive wager is made. The processing unit 300 can control such functionality (read from the sensors, store which players (seats) have placed the progressive wager, and cause the respective progressive wager lights to light up for each progressive wager placed). The processing unit can be connected to an electronic lucky seat display 304 (such as lucky seat display 202) and an electronic progressive display 305 (such as progressive jackpot meter 201). The lucky seat display 304 can also be a set of lights (one at each of the player seats) which is configured so that only the light at the lucky seat will light up, thereby indicating the current lucky seat. The processing unit can also be connected to a reset button 303 which is pressed by the dealer when all bets on the table have been collected and bets for a new game are being accepted (and thus all the progressive wager lights are turned off). The processing unit can also be connected to a bets closed button 302 which is used by the dealer when no further progressive wagers can be made so that the lucky seat can be determined and displayed, as well as the proper contribution to the progressive jackpot is computed and added to the progressive jackpot. The processing unit 300 can also be connected to a ROM 306 which contains programs (computer readable instructions) to cause the processing unit to implement the jackpot system described herein and also a RAM 306 which allows the processing unit 300 some memory in order to store data as needed (such as storing the current amount of progressive jackpot, etc.) The processing unit 300 can also be connected to other devices as well (not pictured) such as a casino network, other tables that can share the same progressive jackpot, etc. The processing unit 300 can also be connected to an I/O device 307. The I/O device 307 can be a keypad with a screen and can be used by the dealer to communicate with the processing unit 300 to tell the processing unit 300 when a player has hit the progressive jackpot and which jackpot outcome has occurred so the system can deduct the proper amount from the jackpot meter. Also not illustrated is a storage device (such as a hard disk drive, etc.) which reads a non-transitory storage medium (e.g., hard disk) which stores instructions/programs to implement any and all of the methods described herein.

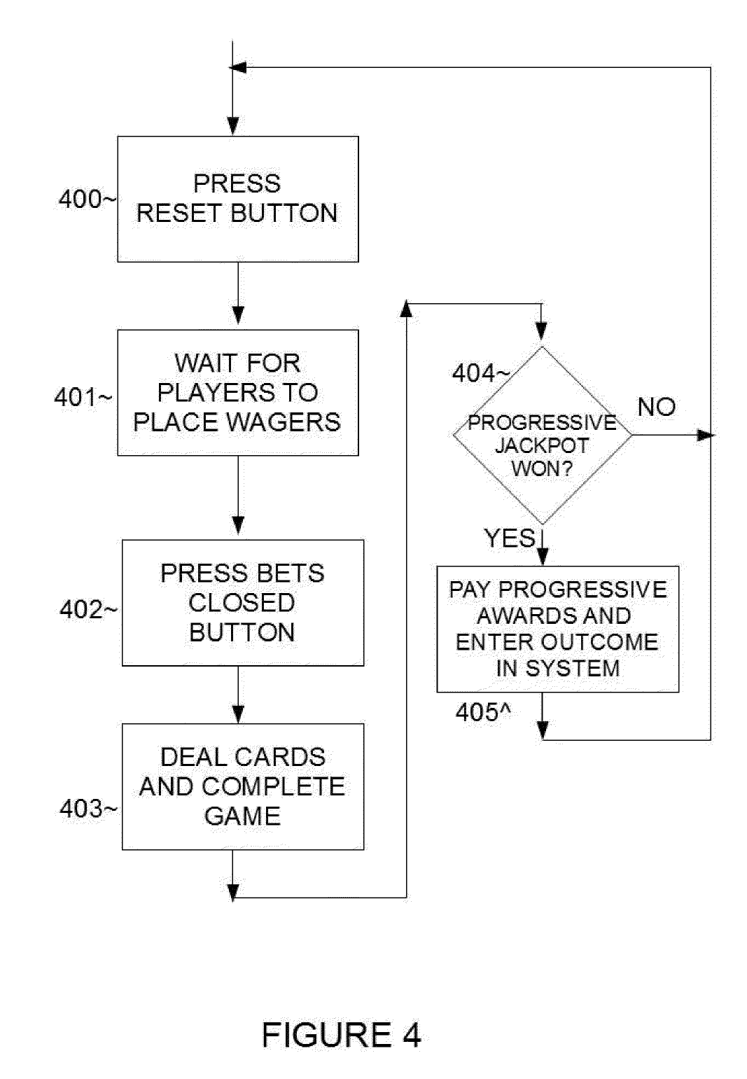

FIG. 4 is a flowchart illustrating an exemplary method of implementing a progressive jackpot dealing procedure, according to an embodiment.

The method can begin with operation 400, wherein the dealer presses the reset button 303. This turns off all the progressive wager lights and now players are instructed to place their bets.

From operation 400, the method proceeds to operation 401, wherein the dealer waits for the players at the table to place their wagers (main wagers and progressive wagers). This is done as illustrated in operation 100.

From operation 401, the method proceeds to operation 402, wherein when all the players have placed their bets the dealer presses the bets closed button 302. This prevents players from now placing progressive wagers (thus, those players who did not place the progressive wager cannot now do so on this game). This also causes the system to increase the progressive jackpot (which is displayed on the progressive jackpot meter 201) by the appropriate amount. This also causes the system to randomly select the lucky seat and display the selected lucky seat on the lucky seat display 202.

From operation 402, the method proceeds to operation 403, wherein the dealer deals the cards and completes the game. This includes resolving all of the main wagers. This is done as in operations 103-104.

From operation 403, the method proceeds to operation 404, which determines whether a progressive jackpot was won (one of the outcomes, such as those in Table II, have occurred). If a progressive jackpot was not won, then the method proceeds to operation 400 where a new game can begin.

If a progressive jackpot was won, then the method proceeds to operation 405, wherein the dealer pays the respective progressive awards to the players. The dealer would also inform the system of the outcome so that the system can reduce the progressive jackpot by the appropriate amount. For example, in the above example, if the progressive jackpot is at $30,000 and a natural tie all same suit occurs. There are 5 players playing at the table and players at seats 1, 4, 6 made the progressive wager. Seat 5 is chosen as the lucky seat (either nobody is playing at seat 5 or the player at seat 5 did not make the progressive wager). The natural tie all same suit occurs, and (according to Table II) starts with a base of 20% of the jackpot meter, or $6,000. All three progressive wager players get 8% of the $6,000 or $480. The jackpot meter is reduced by $480 times 3, resulting in a new jackpot amount of $28,560. The dealer would indicate using the I/O device 307 the outcome (natural tie all same suit) so that the system can compute how much to reduce the jackpot meter by. The system knows how many players are playing the progressive and whether the player at the lucky seat played the progressive and so it can automatically compute how much the jackpot meter should be reduced by once it knows the outcome (which typically would have to be input by the dealer).

As a further example, four players bet the progressive (seats #2, #4, #7, #8). Seat #3 is chosen as the Lucky Seat. The Player hand is Kd 9h and the Dealer hand is Kd 9h (an identical natural 9 tie). This is the 100% progressive payout. The bettors in seats #2, #4, #7, #8 each receive 8% of the jackpot (note that jackpot as used herein also refers to progressive jackpot or the amount on the progressive meter). After the payout, (32%)*($8,000) or $2,560 is added to the progressive as a pro-rated re-seed.

As yet another example, four players bet the progressive (seats #2, #4, #7, #8). Seat #2 is chosen as the lucky seat. The Player hand is Kd 9h and the Dealer hand is Kd 9h. This is the 100% progressive payout (another identical natural 9 tie). The bettor in seat #2 receives 44% of the jackpot, and the bettors in seats #4, #7, #8 each receive 8% of the jackpot. After the payout, (68%)*($8,000) is added to the progressive as a pro-rated re-seed (thus the amount added to the jackpot is $5,440).

In a last example, four players bet the progressive (seats #2, #4, #7, #8). Seat #2 is chosen as the lucky seat. The Player hand is Kd 8d and the Dealer hand is 5d 3d. This suited natural tie pays the 20% progressive payout. The bettor in seat #2 receives 44% of 20% of the jackpot, and the bettors in seats #4, #7, #8 each receive 8% of 20% of the jackpot. There is no re-seed, as re-seeding only happens on the identical natural 9 tie.

Note the progressive bettor has a (1/8)(44%)+(7/8)(8%)=12.5% average expected share of a jackpot, when it hits. This 12.5% average share is the same, regardless of the number of progressive bettors at the table. Thus, the Lucky Seat mechanism provides a fair distribution of the progressive jackpot, where a bettor expects an average 12.5% share of the jackpot, whether alone at the table, or playing with up to 7 other progressive bettors.

In a further embodiment, there can be more than one randomly chosen lucky seat. For example, there can be two randomly chosen lucky seats at the table (or any other number up to the amount of seats at the table). Each of the lucky seats would award a greater award to the player sitting at them (who plays the progressive) than progressive players who are not at lucky seats. In a further embodiment, there can be different types of lucky seats, for example in a system that has two lucky seats there would be a first lucky seat and a second lucky seat. The first lucky seat would pay more (to a winning progressive player) than the second lucky seat does (to a winning progressive player), and the second lucky seat would still pay more than those (winning progressive) players not sitting at either of the lucky seats.

In a further embodiment, there is no lucky seat. The jackpot is divided by eight (or how many seats there are at the table) to determine a share amount, and then the share amount is given to each player at the table that is playing the progressive.

In yet a further embodiment, there can be a random “unlucky seat” at the table which would earn less to a winning progressive player than other players who are either at lucky seats or regular seats (not lucky seats and not unlucky seats). A game can have any number of lucky seats, regular seats, and unlucky seats.

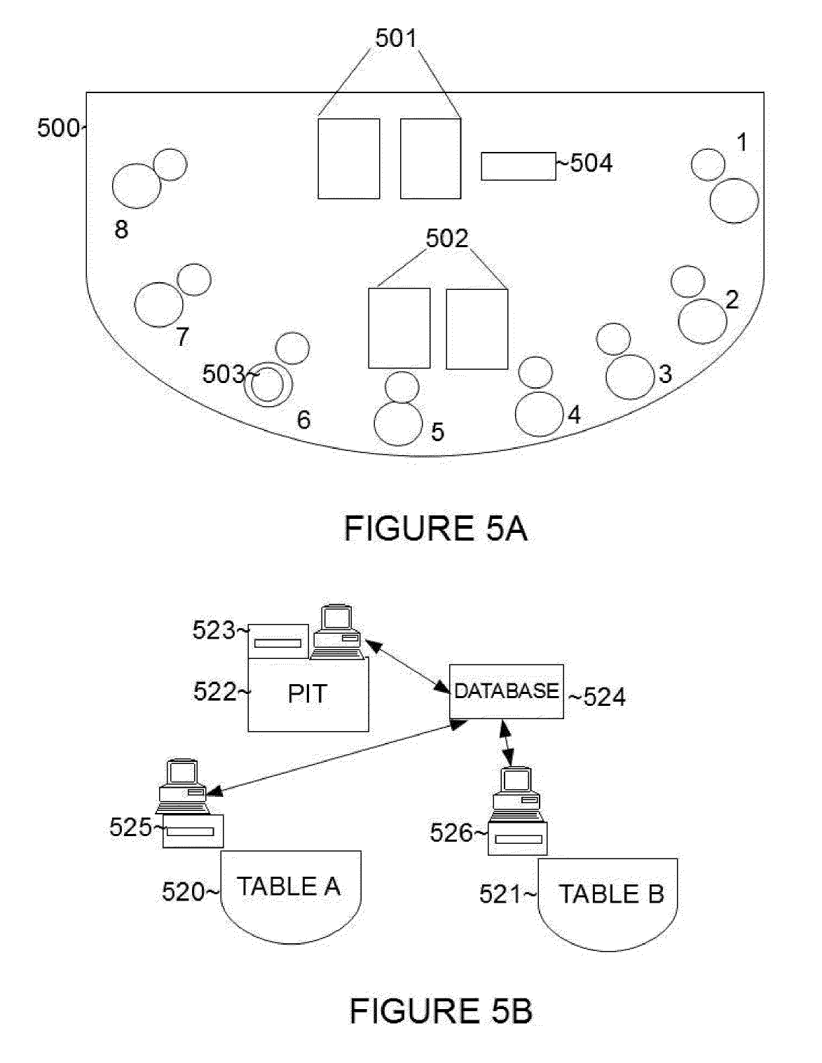

FIG. 5A is a drawing illustrating a gaming table, according to an embodiment.

A physical gaming table 500 (typically made of wood with felt on top with the layout imprinted on it) is used to play the game in a physical real world casino. One example of a table that can be used in a physical casino is illustrated in U.S. Design Pat. No. D263,975 which is incorporated by reference herein in its entirety. The layout on top of the felt has imprinted on it seven betting circles as illustrated in FIG. 5A, each betting circle is where the respective player can place their chips (wager). The felt can be green and the imprinted betting circles can be white, although of course any color scheme can be used. Such a table can accommodate any number of players (such as seven as illustrated) or any other number (e.g. 2-10). All players play simultaneously against the dealer as known in the art. A player's hand 502 and a dealer's (or banker's) hand 501 are shown. A player's wager 503 is shown in the form of a chip or chips and is placed inside the player's betting circle. Also shown is a smaller progressive wager betting circle for each betting circle for each player. The dealer's area can also accommodate a physical card reader 504 for reading the dealer's hole card (in a blackjack embodiment) as described in U.S. Pat. No. 5,681,039, which is incorporated by reference in its entirety for all purposes. The physical card reader can be an electronic card reader which electronically scans a face down card and lights up a particular light (e.g., LED, etc.) if the face down card is a 10 or ace (which would give the dealer blackjack when the dealer's up-card is an ace or 10 respectively) otherwise a different light (e.g., a “green light”) lights up telling the dealer that the hole-card does not give the dealer blackjack and thus the dealer can continue dealing.

While not shown, the game can also be offered with any type of additional side wager in order to generate more action for the casino and more excitement for the players. Also not pictured in FIG. 5A is an electronic mechanical shuffler such as that described in U.S. Pat. No. 8,025,294 which is incorporated by reference here in its entirety which can optionally be used by the dealer to shuffle the deck or decks of cards. Also not pictured in FIG. 5A is an optional shoe which the cards can be placed into and dealt out of by the dealer, such as the shoe described in U.S. Pat. No. 4,457,512 which is incorporated by reference herein in its entirety.

FIG. 5B is a block diagram illustrating an electronic player tracking system associated with each gaming table, according to an embodiment.

When players play casino table games the casino can typically track the player so that the casino knows how much gaming action a player is giving the casino and hence how much to reward each player with complimentaries (free or discounted rooms, food, etc.) Such a system is described in U.S. Pat. No. 5,836,817, which is incorporated by reference herein in its entirety for all purposes. Each player can have their own players card which is a plastic card that has their name imprinted on it and computer readable indicia (e.g., a magnetic stripe) which stores an identification number of the player's card (and hence the identification number of the player who owns the card). The player's card can be swiped through an electronic card readers 323, 325, 326 which can be electronic read and the data therein transmitted to the associated computer.

A gaming table A 520 (which can be used to play any method described herein) and a gaming table B 521 (which can be used to play any method described herein) can be associated with a pit 522 (which has its own computer) which has a card reader 523 to read the electronically encoded information on a player's card (the card reader can also be located at the tables themselves) and transmit the information to an associated computer which can communicate information contained on the player's card (e.g., an identification number of the player associated with the card) to the electronic database 524 along with play data relating to the player who owns the player's card. Table A 520 has its own card reader 525 and associated computer (the one next to card reader 525 which receives information from the card reader 525) and table B 521 also has its own card reader 526 and associated computer (the one next to card reader 326 which receives information from the card reader 526). The computers at table A 520 and table B 521 are connected to the electronic database 524. Casino employees can enter data regarding each player's play (for those players that present a players card) into a computer at the table or at the pit which transmits the play data (e.g., average bet/wager amount, time of play, etc.) to the electronic casino database 524 that stores playing history information for players at the casino. The computers illustrated in FIG. 5B can all have the structure as illustrated in FIG. 5A.

FIG. 6A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety.

A processing unit 600 (such as a microprocessor and any associated components) is connected to an output device 601 (such as an LCD monitor, touch screen, CRT, etc.) which is used to display to the player any aspect of the method, and an input device 602 (e.g., buttons, a touch screen, a keyboard, mouse, etc.) which can be used to input from the player any decision made by the player. All methods described herein can be performed by the processing unit 600 by loading and executing respective instructions. The processing unit 600 can also be connected to a network connection 603, which can connect the electronic gaming device to a computer communications network such as the Internet, a LAN, WAN, etc. The processing unit 600 is also connected to a RAM 604 and a ROM 605. The processing unit 600 is also connected to a storage device 606 which can be a DVD-drive, CD-ROM, flash memory, etc. Multiple such processing units can also work in collaboration with each other (in a same or different physical location). A non-transitory computer readable storage medium 607 can store a program which can control the electronic device to perform any of the methods described herein and can be read by the storage device 606. The processing unit 600 can also be connected to a financial apparatus 608 which can receive cash and convert the received cash into playable credits for use by the player when playing the electronic device. When the player decides to cash out any remaining credits, the financial apparatus 608 can issue coins or a cashless ticket (voucher) for the remaining credits which is redeemable by the player.

The methods herein can also be applied to lottery, bingo, or keno games as well. For example, an optional progressive bet can be added to such games with a cap on the number of people who can participate in the progressive game. The progressive game can then be implemented using any of the methods described herein (although instead of a “lucky seat” a “lucky ticket” can be selected). For example, each ticket can have a unique number associated it and a random number can be selected as the “lucky ticket.” For example, a lottery game can have 100 progressive bets available (thus no more than 100 can play). The progressive jackpot can be triggered based on the lottery numbers drawn. For example, if the lottery has five numbers (although it can comprise any amount of numbers) and all six numbers are consecutive (e.g., 28, 29, 26, 30, 27) then this would trigger a progressive jackpot distribution. The distribution would be made as described, with a lucky ticket being identified (e.g., a random number from 1 to 100 can be generated representing the number of the lucky ticket) which would win a larger share of the jackpot. A chart such as that illustrated in Table II can be used as applied to a lottery game, for example, if the first four numbers drawn are a four number straight (e.g., 1, 2, 3, 4, etc.) then 100% of the jackpot is the payout used for the progressive players, and if the first three numbers drawn are a three number straight (e.g., 1, 2, 3) then 20% of the jackpot will be the payout used for the progressive players. The payout can then be divided as described herein, for example the lucky ticket(s) would get a larger share of this payout than the remaining ticket(s).

The game can also be applied to roulette. For example, a chart can be used in which if the next four numbers are a four-number straight or 4 of a kind (e.g.9,9,9,9; 1, 2, 3, 4; 12, 13, 14, 15, etc.) then 100% of the jackpot will be the payout to which the progressive players will get their share of, if the next three numbers are a three-number straight of 3 of a kind (e.g., 4, 4, 4; 20, 21, 22) then 20% of the jackpot will be the payout to which the jackpot players will get their share of. As above, there can be a lucky seat (or seats) at the roulette table and the jackpot can be distributed as described herein. The progressive wager can be accepted before a sequence of spins begins and will not be accepted until a predetermined number of spins (e.g., five) is over which can be used to determine whether the progressive jackpot is reached, and then the progressive wager will be accepted again from players.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

FIG. 6B is a block diagram illustrating an exemplary network configuration to implement a player playing an online version of the methods described herein. All the methods described herein can be implemented on an online casino for real money (credits which are purchased for cash and are redeemable for cash) or for non-cash value credits. A player uses a personal computer 610 (e.g., cell phone, tablet, PC, etc.) can connect to a server 611 (which can have the structure illustrated in FIG. 5A) using a computer communications network such as the Internet. The server 611 hosts an online casino which determines the outcomes of the game and serves the outcomes to the computer 610 so the computer 610 displays the outcomes to the player. Other users can also play at the online casino hosted by the server 611 simultaneously, such as using a cell phone 612 with wireless internet connectivity. Any number of players connected to the internet can play contemporaneously at the sever 611. The general structure of online casinos is well known in the art.

It is noted that the methods described herein can be played with any number of standard decks of 52 cards (e.g., 1 deck to 10 decks). A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation. All features in all documents incorporated by reference herein can be combined with any feature(s) described herein, and also with all other features in all other documents incorporated by reference, without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for implementing a wagering game, the method comprising:
using an electronic progressive wagering system, displaying an electronic jackpot meter indicating a current amount of a progressive jackpot;
receiving main wagers from a plurality of players at a gaming table;
receiving optional progressive wager from some of the plurality of players at the gaming table;
determining a random lucky seat at the gaming table;
identifying the lucky seat at the gaming table;
dealing and completing the wagering game;
determining whether an outcome in the wagering game qualifies for a progressive jackpot payout;
upon the outcome not qualifying for a progressive jackpot payout then not paying a progressive jackpot payout to any of the players; and
upon the outcome qualifying for a progressive jackpot payout, then paying a progressive jackpot payout to players who made the progressive wager,
wherein when a lucky player out of the plurality of players is positioned at the lucky seat and makes the optional progressive wager, then the lucky player wins a larger progressive jackpot payout than other players who made the progressive wager.

2. The method as recited in claim 1, wherein the identifying the lucky seat at the gaming table is done by displaying an identifier of the lucky seat on an electronic output display located at the table.

3. The method as recited in claim 1, wherein the wagering game is baccarat.

4. The method as recited in claim 3, wherein one outcome that qualifies for a progressive jackpot payout is that the player and banker both tie with a natural 9 using identical cards.

5. The method as recited in claim 4, wherein when the tie with the natural 9 using identical cards occurs, then a maximum amount of the progressive jackpot is distributed.

6. The method as recited in claim 4, wherein another outcome that qualifies for a progressive jackpot payout is that the player and banker both tie with a natural 8 using identical cards.

7. The method as recited in claim 1, wherein players aside from the lucky player all receive equal progressive jackpot payouts.

8. The method as recited in claim 1, wherein when the player positioned at the lucky seat did not make the progressive wager than all players who made the progressive wager receive an equal progressive jackpot payout.

9. An apparatus, comprising:
an electronic progressive jackpot meter;
an electronic lucky seat display;
an electronic processing unit, the processing unit configured to:
display a current amount of a progressive jackpot on the electronic jackpot meter;
determine a random lucky seat at the gaming table;
display the lucky seat on the lucky seat display;
increase the progressive jackpot meter based on a contribution rate and a number of players making the progressive wager; and
update the progressive jackpot meter by subtracting an amount paid during the wagering game;
wherein game rules provide that after the wagering game is dealt and completed, upon an outcome not qualifying for a progressive jackpot payout then a progressive jackpot payout is not paid to any of the players and upon the outcome qualifying for a progressive jackpot payout then a progressive jackpot payout is paid to players who made the progressive wager, wherein when a lucky player out of the plurality of players is positioned at the lucky seat and makes the optional progressive wager, then the lucky player wins a larger progressive jackpot payout than other players who made the progressive wager.

10. The apparatus as recited in claim 9, wherein the electronic processing unit is further configured such that the identifying the lucky seat at the gaming table is done by displaying an identifier of the lucky seat on an electronic output display located at the table.

11. The apparatus as recited in claim 9, wherein the wagering game is baccarat.

12. The apparatus as recited in claim 11, wherein the game rules further provide that one outcome that qualifies for a progressive jackpot payout is that the player and banker both tie with a natural 9 using identical cards.

13. The apparatus as recited in claim 12, wherein the game rules further provide that when the tie with the natural 9 using identical cards occurs, then a maximum amount of the progressive jackpot is distributed.

14. The apparatus as recited in claim 12, wherein the game rules further provide that another outcome that qualifies for a progressive jackpot payout is that the player and banker both tie with a natural 8 using identical cards.

15. The apparatus as recited in claim 9, wherein the game rules further provide that players aside from the lucky player all receive equal progressive jackpot payouts.

16. The apparatus as recited in claim 9, wherein the game rules further provide that when the player positioned at the lucky seat did not make the progressive wager than all players who made the progressive wager receive an equal progressive jackpot payout

17. A method for implementing a wagering game, the method comprising:
using an electronic progressive wagering system, displaying an electronic jackpot meter indicating a current amount of a progressive jackpot;
receiving main wagers from a plurality of players at a gaming table, the gaming table having N seats;
receiving optional progressive wager from some of the plurality of players at the gaming table;
dealing and completing the wagering game;
determining whether an outcome in the wagering game qualifies for a progressive jackpot payout;
upon the outcome not qualifying for a progressive jackpot payout then not paying a progressive jackpot payout to any of the players;
upon the outcome qualifying for a progressive jackpot payout, then determining a share amount as an amount of the progressive jackpot to be awarded divided by N; and
awarding the share amount to all of the players at the table that played the progressive.

18. A method for implementing a roulette game with a progressive jackpot, the method comprising:
using an electronic progressive wagering system, displaying an electronic jackpot meter indicating a current amount of a progressive jackpot;
receiving main wagers from a plurality of players at a roulette table, the roulette table having N seats;
receiving optional progressive wager from some of the plurality of players at the roulette table;
spinning a wheel at the roulette table at least one spin;
determining whether an outcome of the at least one spin qualifies for a progressive jackpot payout;
upon the outcome not qualifying for a progressive jackpot payout then not paying a progressive jackpot payout to any of the players;
upon the outcome qualifying for a progressive jackpot payout, then determining a share amount as an amount of the progressive jackpot to be awarded divided by N; and
awarding the share amount to all of the players at the roulette table that played the progressive.

19. A method for implementing a roulette game with a progressive jackpot, the method comprising:
using an electronic progressive wagering system, displaying an electronic jackpot meter indicating a current amount of a progressive jackpot;
receiving main wagers from a plurality of players at a roulette table;
receiving optional progressive wager from some of the plurality of players at the roulette table;
determining a random lucky seat at the roulette table;
identifying the lucky seat at the roulette table;
spinning a wheel at the roulette table at least one spin;
determining whether an outcome of the at least one spin qualifies for a progressive jackpot payout;
upon the outcome not qualifying for a progressive jackpot payout then not paying a progressive jackpot payout to any of the players; and
upon the outcome qualifying for a progressive jackpot payout, then paying a progressive jackpot payout to players who made the progressive wager,
wherein when a lucky player out of the plurality of players is positioned at the lucky seat and makes the optional progressive wager, then the lucky player wins a larger progressive jackpot payout than other players who made the progressive wager.
